(19) United States
(12) Patent Application Publication
(10) Pub. No.: US 2007/0001103 A1
(43) Pub. Date: Jan. 4, 2007

(54) Apparatus and methods for reducing noise in an optoelectronic device

(76) Inventor: John LaBelle, Long Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/214,228

(22) Filed: Aug. 29, 2005

Related U.S. Application Data
(60) Provisional application No. 60/696,401, filed on Jul. 1, 2005.

(51) Int. Cl. G02B 23/00

(52) U.S. Cl. 250/214 SW

(57) ABSTRACT

In various embodiments, a telescope comprises a telescope body, telescope optics, a two-dimensional sensor array, and power supply circuitry. The power supply circuitry comprises a switching power supply configured to provide power to the two-dimensional sensor array and sensing circuitry. During at least a portion of data acquisition, the switching power supply is shut off and the two-dimensional sensor array is powered by a non-switching power source, thereby reducing noise.

### RELATED APPLICATIONS

This application claims the benefit of U.S. Provisional Application No. 60/696,401, entitled “Apparatus and Methods for Reducing Noise in an Optoelectronic Device,” and filed Jul. 1, 2005, which is hereby incorporated by reference herein in its entirety.

### BACKGROUND

1. Field of the Invention

The present invention relates to reducing noise in optoelectronic devices.

2. Description of the Related Art

Optoelectronic imaging devices such as a CMOS or CCD image sensors are used in a wide range of scientific, recreational and industrial applications. However, optoelectronic imaging sensors are susceptible to noise generated by internal or external circuitry that can reduce image quality. For example, CCD image quality can be severely reduced by noise under low lighting conditions.

CCD image sensors generally comprise an array of photodiodes that operate by converting light energy in the form of photons into an electrical charge. Electrons generated in semiconductor by photons incident thereon are stored in potential wells and are subsequently transferred to shift registers and output to an amplifier. Thus, for each pixel, the output signal of the amplifier is generally proportional to the number of photons incident on a photodiode in the array.

Noise caused by external or internal circuitry introduces error during the transfer and amplification process. If the signal is low, the error introduced by the noise can have a dramatic effect on the overall image. The signal may be low, for example, under low lighting conditions when a small number of photons incident on the photodiodes generate relatively small electrical charge as compared with the noise.

In a wide range of application, the signal-to-noise ratio is reduced due low light levels. For example, high performance optical telescopes for the amateur and more advanced enthusiast may include a conventional optoelectronic device for recording images under low light conditions. Noise from internal circuitry reduces the sensitivity the optoelectronic device, making it difficult to clearly image light from deep-sky objects, stars, objects in our solar system and even earth satellites. Thus, it would be advantageous to develop a technique and system for effectively reducing noise caused by circuitry in devices with optoelectronic imaging sensors.

### SUMMARY

In certain embodiments, a telescope includes a telescope body, telescope optics, a two-dimensional sensor array, and power supply circuitry. The power supply circuitry includes a switching power supply configured to provide power to the two-dimensional sensor array. During at least a portion of data acquisition, the switching power supply is shut off and the two-dimensional sensor array is powered by a non-switching power source, thereby reducing noise.

In one embodiment, a telescope includes a telescope body and telescope optics at least a portion of which are disposed in the telescope body. The telescope optics are configured to receive light from a celestial object and form an optical image at an image plane. The telescope also includes a two-dimensional sensor array disposed at the image plane and power supply circuitry having first and second states. The power supply circuitry includes at least one switching power supply configured to provide power to the two-dimensional sensor array in the first state. The power supply circuitry also includes at least one non-switching power source configured to provide power to the two-dimensional sensor array in the second state. In the second state, the at least one switching power supply is shut-off, thereby reducing noise.

In one embodiment, a telescope includes a telescope body and telescope optics at least a portion of which is disposed in the telescope body. The optical imaging system is configured to receive light from an object and form an optical image at an image plane. The telescope also includes a two-dimensional sensor array disposed at the image plane, image acquisition circuitry, and power supply circuitry having first and second states. The power supply circuitry includes at least one switching power supply configured to provide power to the two-dimensional sensor array or the image acquisition circuitry in the first state. The power supply circuitry also includes at least one non-switching power source configured to provide power to the two-dimensional sensor array or the image acquisition circuitry in the second state. In the second state, the power provided to the two-dimensional sensor array or image acquisition circuitry by the at least one switching power supply is reduced relative to the power provided to the two-dimensional sensor array or image acquisition circuitry by the at least one switching power supply in the first state, thereby reducing noise.

In one embodiment, a method of capturing an image formed by a telescope includes powering at least a portion of an imager comprising a two-dimensional sensor array and image acquisition circuitry using at least one switching power supply, forming an optical image at the two-dimensional sensor array, detecting a signal from the two-dimensional sensor array with sensing circuitry, and powering the at least a portion of the imager with at least one non-switching power source instead of the switching power supply while detecting the signal.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 is a schematic diagram of an optical imaging system equipped with an imager according to certain embodiments.

FIG. 2 is a schematic diagram of a CCD sensor array usable by the optical imaging system shown in FIG. 1.

FIG. 3A is a block diagram illustrating portions of exemplary circuitry usable by the imager shown in FIG. 1 according to certain embodiments.

FIG. 3B is a block diagram illustrating portions of exemplary circuitry usable by the imager shown in FIG. 1 according to certain other embodiments.

FIG. 4 is a block diagram illustrating portions of an exemplary imager, such as the imager shown in FIG. 1 according to certain embodiments.

FIG. 5 is a block diagram of exemplary power supply circuitry usable by the imager shown in FIG. 1 according to certain embodiments.

FIG. 6 is a flow chart schematically illustrating an exemplary image acquisition process according to certain embodiments.

### DETAILED DESCRIPTION OF CERTAIN PREFERRED EMBODIMENTS

In various embodiments, a telescope comprises a telescope body, telescope optics, a two-dimensional sensor array, and power supply circuitry. The power supply circuitry comprises a switching power supply configured to provide power to the two-dimensional sensor array. During at least a portion of data acquisition, the switching power supply is shut off and the two-dimensional sensor array is powered by a non-switching power source, thereby reducing noise. Other embodiments are also possible.

In particular, in the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present disclosure. The present disclosure, however, may be practiced without the specific details or with certain alternative equivalent components and methods to those described herein. In other instances, well-known components and methods have not been described in detail so as not to unnecessarily obscure aspects of the present disclosure.

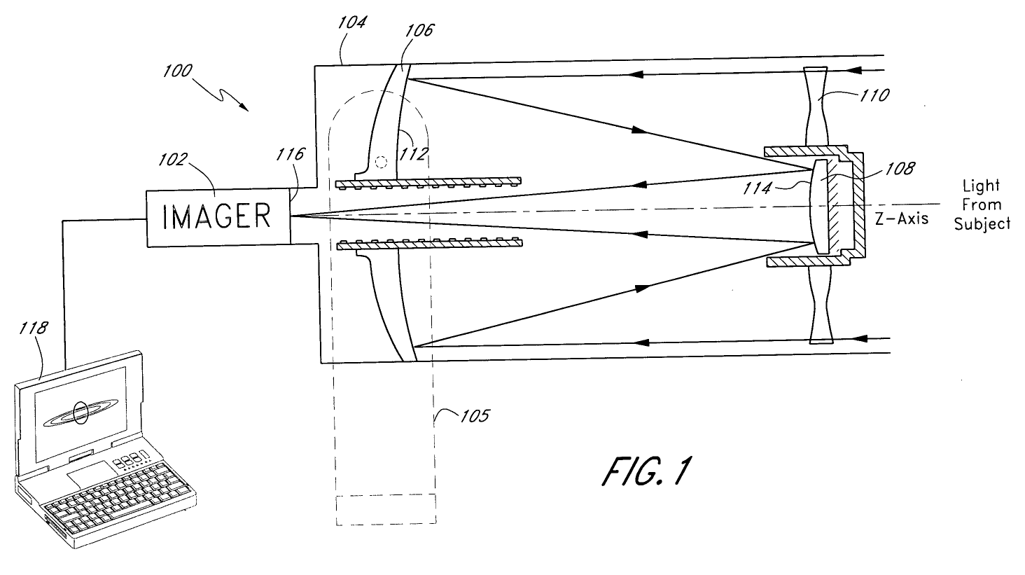

FIG. 1 is a schematic diagram of an imaging system 100 according to certain embodiments. FIG. 1 depicts an imager 102 coupled to an exemplary telescope 104. As schematically illustrated, the exemplary telescope 104 is configured to collect light from an object, such as a celestial object like a star, earth satellite, a deep-sky object, an object in our solar system, etc., and to focus the light onto the imager 102. In certain embodiments, the exemplary telescope 104 is supported by a mount 105 (shown by dashed lines in FIG. 1), which facilitates movement of the exemplary telescope 104 about two orthogonal axes. The imager 102 is configured to generate an electrical signal corresponding to an image of the object.

The exemplary telescope 104 comprises telescope optics, such a lens or mirror, within a telescope body, e.g., a telescope tube. In the embodiment shown in FIG. 1, the telescope optics includes both reflective and refractive optical elements and, thus, is a catadioptric telescope. This particular configuration, which includes the combination of the primary and secondary mirrors 106, 108 and corrector plate 110, may be referred to as a Schmidt-Cassegrain telescope. However, other configurations are possible. Thus, even though depicted as a Schmidt-Cassegrain telescope, the telescope 104 may comprise any reflector-type, refractor-type, or catadioptric telescope. The specific optical systems used might be, for example, Newtonian, Schmidt-Cassegrain, Maksutov-Cassegrain, or any other conventional reflector-type, refractor-type, or catadioptric telescope configured for telescopic use. The telescope 104 may comprise a dome telescope such as are generally operated by professional astronomers. Other configurations, however, may also be employed.

As shown, collimated rays from, for example, a celestial object, are received by the exemplary telescope 104. The collimated light propagates to the primary mirror 106 where the curved concave reflecting surface 112 converts the collimated beam into a converging beam directed toward the secondary mirror 108. The converging beam reflects off the convex curved reflecting surface 114 of the secondary mirror 108. The beam continues to converge toward an image or focal plane 116 where the beam is focused.

An image of the object is formed at the image plane 116. Accordingly, the imager 102 includes a two-dimensional detector array disposed at, near, or with respect to the image plane 116 to record the image of the object. As shown, in certain embodiments, the imager 102 is detachably attached to the exterior of the telescope 104 through a lens (not shown). In certain embodiments, this lens is adjustable, for example, to selectively adjust the focus of the telescope.

In various embodiments, the two-dimensional detector array in the imager 102 comprises, for example, a charge coupled device (CCD) array, a complimentary metal oxide semiconductor (CMOS) image array, or the like. Accordingly, the two-dimensional detector array may comprise an array of photodetectors comprising, for example, semiconductor material that generates photoelectrons when illuminated by light. The amount of light incident on a given photodetector may be quantified by measuring a parameter, such as voltage or current, that is indicative of the amount of photoelectrons produced.

In certain embodiments, the imager 102 additionally includes a memory device (not shown) for storing images generated by the imager 102. The memory device may comprise, for example, a removable or non-removable flash memory device, a miniature hard-drive, or another memory device associated with digital cameras, digital camcorders, cell phones, personal digital assistants (PDAs), other computing devices, or the like. Other memory devices may be used as well.

Although not shown in FIG. 1, the imager 102 may include a display screen for viewing generated images. In addition, or in other embodiments, the telescope 104 may include a display screen for viewing images generated by the imager 102. Such display screens may comprise, for example, a liquid crystal display (LCD) or similar device, such as those associated with digital cameras, camcorders, laptops, cell phones, personal digital assistants (PDAs), other computing devices, or the like. Other displays devices may be used.

As shown in FIG. 1, in certain embodiments, the imager 102 may be configured to communicate with a host system 118. In certain such embodiments, the imager 102 transmits image data to the host system 118, which may be configured to process and/or display images of, e.g., celestial objects, generated by the imager 102.

In an exemplary embodiment, the host system 118 comprises a laptop computer. In other embodiments, the host system 118 may comprise, for example, a computer system, a personal computer, a handheld device, a set top box for a television, a personal digital assistant (PDA), a network, combinations of the same, or the like. Other types of host systems 118 may be used as well. The imager 102 may, for example, transmit the image data to the host system 118 wirelessly, through a direct electrical connection, or through a network connection. In certain embodiments, the imager 102 communicates with the host system 118 through a universal serial bus (USB) adapter. In other embodiments, the imager 102 communicates with the host system 118 through a wireless Ethernet adapter or other network adapter. Other communication links are also possible.

In certain other embodiments, the host system 118 comprises a controller housed with the telescope 104 and/or the imager 102. For example, the host system 118 may comprise one or more controllers, program logic, hardware, software, or other substrate configurations capable of representing data and instructions which operate as described herein or similar thereto. The host system 118 may also comprise controller circuitry, processor circuitry, digital signal processors, general purpose single-chip or multi-chip microprocessors, combinations of the foregoing, or the like.

Although the host system 118 specifically and the imaging system 100 in general are disclosed with reference to their preferred and alternative embodiments, the disclosure is not limited thereby. Rather, a wide number of alternatives for host and imaging systems 118, 100, including alternative devices and arrangements for performing a portion of, one of, or combinations of the functions and alternative functions disclosed herein. Various functions, for example, may be performed in either the host or the imager 102, by both, and/or by other components as well.

As discussed above, light from celestial objects such as deep-sky objects, stars, objects in our solar system, earth satellites, and the like may be weak and difficult to detect. To generate bright images, the imager 102 may be exposed to such light for relatively long periods of time. The quality of such images is effected by factors such as the amount of light available from the objects as well as atmospheric conditions that distort the light from the objects. The internal circuitry of the imager 102 can also generate noise that reduces image quality. For example, in certain embodiments, the imaging system 100 and/or the imager 102 are mobile and comprise internal power converters that generate noise when converting a power signal from a first voltage level (e.g., from an internal battery or external power connection) to a second voltage level. In optical astronomy applications where light from a distant object is already weak, noise caused by internal circuitry or other sources can unsatisfactorily reduce the quality of the image.

In an exemplary embodiment, the imager 102 comprises a CCD sensor array. Generally, CCD sensor arrays are silicon-based integrated circuits including a dense matrix of photodiodes that operate by converting light energy in the form of photons into an electronic charge. In certain embodiments described herein, the noise generated by the internal circuitry of the imager 102 is reduced while this electronic charge in the CCD sensor array is sensed.

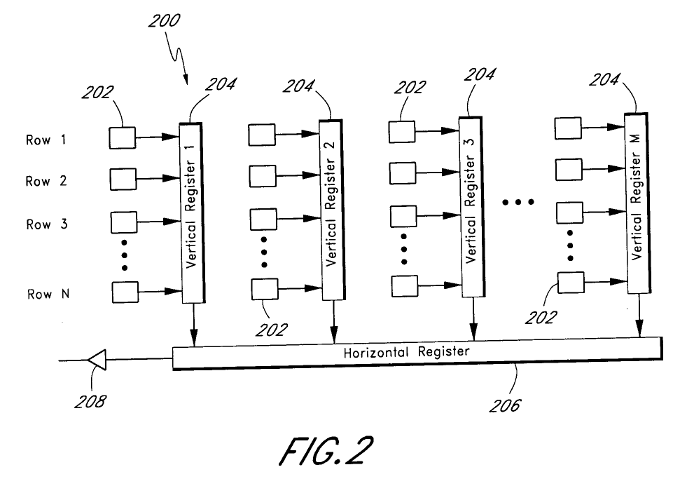

For example, FIG. 2 is a block diagram of a CCD sensor array 200 usable by the imaging system 100 shown in FIG. 1. The CCD sensor array 200 includes a plurality of photodiodes 202 arranged in an array of N rows and M columns. When the photodiodes 202 are exposed to light, electrons (referred to as photoelectrons) are excited into the conduction band of semiconductor material forming the photodiodes 202. These electrons accumulate and are stored in potential wells in the photodiodes 202. After a period of exposure, the accumulated electrons are transferred from the N rows of photodiodes 202 to M vertical registers 204 corresponding to the M columns of photodiodes 202.

Various schemes can be employed to transfer charge in the rows. For example as discussed below, in certain embodiments, the N rows may be transferred to the vertical registers 204 at different times. In certain such embodiments, for instance, electrons in a first set of rows (e.g., odd numbered rows) are transferred out of the CCD sensor array 200 and then electrons in a second set of rows (e.g., even numbered rows) are transferred out of the CCD sensor array 200. However, for purposes of this example, it is assumed that the electrons in the N rows are transferred to the vertical shift registers at the same time.

The N rows of electronic charge stored in the M vertical registers 204 are then shifted, one row at a time, into a horizontal register 206. After the M vertical registers 204 shift a first row (e.g., Row N shown in FIG. 2) of electronic charge to the horizontal register 206, the horizontal register 206 shifts the M electronic charges to an amplifier 208 so that, as discussed in more detail below, the electronic charges can be read or sensed to determine the relative intensity of light incident on the corresponding photodiodes 202. As described above, in various embodiments the amount of charge, in general, is proportional to the approximate number of photons incident on the corresponding photodiodes 202. This amount of charge may be determined, for example, by measuring a parameter such as voltage or current. After the horizontal register 206 shifts the first row of M electronic charges to the amplifier 208, the M vertical registers 204 shift a second row of electronic charge to the horizontal register 206 and so forth until the electronic charges from the N rows have been sensed.

As the horizontal register 206 shifts the electronic charges to the amplifier 208 to be sensed, noise from electrical circuitry is added to the electronic charges. This noise can introduce error to the measured relative intensity of light incident on the photodiodes 202 and reduce overall image quality. If the signal-to-noise ratio is low (e.g., when detecting light from deep space objects at night), the error introduced by the noise can dramatically diminish the accuracy of the measured relative intensity of light incident on the photodiodes 202. Thus, according to certain embodiments, the noise introduced by the electrical circuitry is reduced while the horizontal register 206 shifts the electronic charges to the amplifier 208 to be sensed. In certain such embodiments, the noise is curtailed by turning off switching power supplies while the horizontal register 206 is transferring the electronic charges to be sensed by the sensing circuitry.

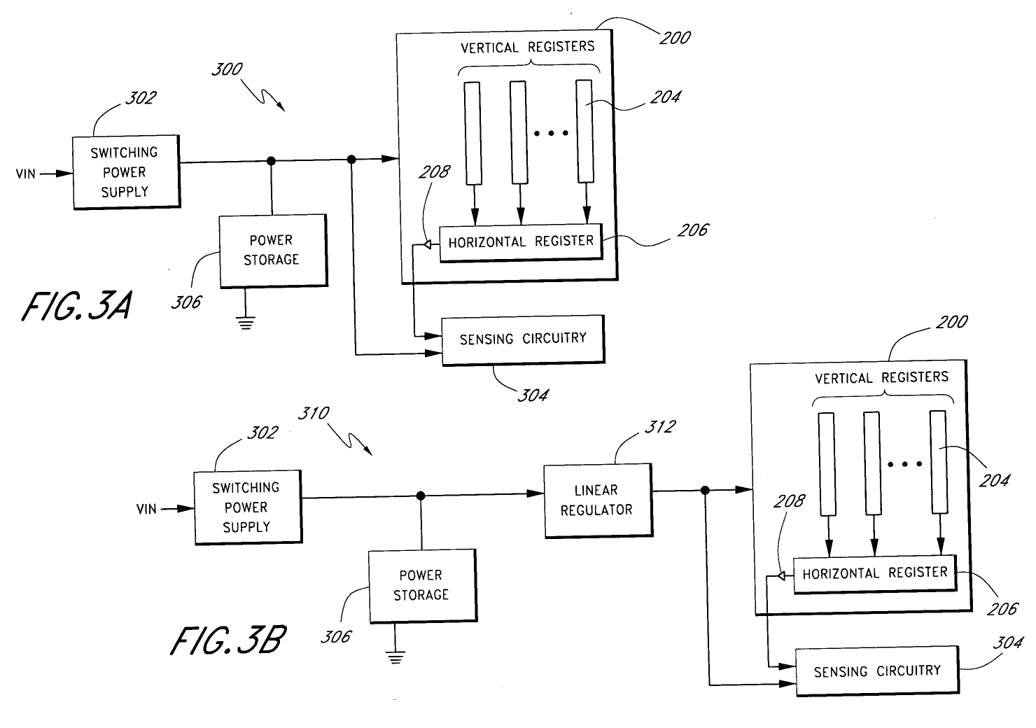

FIG. 3A is a block diagram illustrating portions of exemplary circuitry 300 usable by the imager 102 shown in FIG. 1 according to certain embodiments. The exemplary circuitry 300 includes a switching power supply 302 electrically coupled to a CCD sensor array 200, such as the CCD sensor array 200 shown in FIG. 2, sensing circuitry 304, and a power storage device 306. For illustrative purposes, the photodetectors 202 shown in FIG. 2 are not shown in FIGS. 3A or 3B. The switching power supply 302 is configured to receive an input voltage VIN and to convert the input voltage VIN to one or more voltages that are usable by the CCD sensor array 200 and the sensing circuitry 304. As discussed below, the sensing circuitry 304 according to certain embodiments produces a digital signal indicative of the quantity of electronic charges provided by the horizontal register 206 of the CCD sensor array 200.

The input voltage VIN may be provided, for example, by an internal (e.g., a battery) or an external power source. In certain embodiments, the switching power supply 302 converts the input voltage VIN from, for example, a direct-current (DC) signal to one or more other DC signals, from an alternating-current (AC) signal to one or more DC signals, from a DC signal to one or more AC signals, or combinations of the foregoing.

In an exemplary embodiment, the input voltage VIN is provided through a USB connection from an external controller, such as the host system 118 shown in FIG. 1. In certain such embodiments, the input voltage VIN is approximately +5 VDC. In certain such embodiments, the switching power supply 302 converts the input voltage VIN from a first voltage level to one or more voltage levels usable by the CCD sensor array 200 and other circuitry, such as the sensing circuitry 304.

Generally, switching-mode power supplies, such as the switching power supply 302, switch at predetermined frequencies to increase efficiency (i.e., reduce power dissipation) as compared to, for example, regulators. For example, in certain embodiments, the switching power supply 302 switches at approximately 1.4 MHz. However, the output of switching-mode power supplies generally includes noise such as a relatively low level ripple at the switching frequency, high frequency ripple from pulse width modulation used to obtain a desired line and load regulation, switching noise at substantially the same frequency as the pulse width modulation, and other noise at random frequencies. Attempts are generally made to filter such noise. However, even with filtering, noise from the switching power supply 302 can still be added to the signal obtained by measuring the electronic charges. This noise may be introduced, for example, as the electronic charges from the horizontal register 206 are amplified by the amplifier 208 and sensed by the sensing circuitry 304 and converted into a digital signal.

In certain embodiments, the switching power supply 302 provides power to the CCD sensor array 200 during an image exposure (e.g., while incident photons are causing electrons to be accumulated and stored in potential wells in the photodiodes 202 shown in FIG. 2). In certain such embodiments, the switching power supply 302 is also on (e.g., supplying power) while the electronic charges are transferred to the vertical registers 204 and while successive rows of electronic charge are transferred from the vertical registers 204 to the horizontal register 206. Other configurations and approaches are also possible.

In certain embodiments, when the switching power supply 302 is on, charge from the switching power supply 302 is stored in the power storage device 306. The power storage device 306 may include, for example, one or more capacitors configured to be charged by the switching power supply. In an exemplary embodiment, the power storage device 306 includes a battery. As shown, in certain such embodiments, the one or more capacitors are coupled between the output of the switching power supply 302 and ground, and filter the output of the switching power supply 306 when the switching power supply 302 is on.

To reduce noise, the switching power supply 302 is turned off while the horizontal register 206 transfers the electronic charges to the sensing circuitry 304 or the electronic charge or a property thereof (e.g., voltage ) is measured by the sensing circuitry 304. In certain embodiments, the horizontal register 206 performs measurements on a row of electronic charge in the horizontal register using the sensing circuitry 304 in a time ranging between approximately 180 μs and approximately 720 μs. During this time, the switching power supply 302 is turned off and the charge stored in the power storage device 306 provides power to the CCD sensor array 200 and other circuitry, such as the sensing circuitry 304. In certain embodiments, the switching power supply 302 is turned off a sufficient amount of time before the horizontal register 206 transfers the electronic charges to the sensing circuitry 304 so as to provide time for the switching power supply 302 to settle. In certain such embodiments, for example, the switching power supply 302 is turned off for a total of approximately 1.0 ms when a row of electronic charge or a property thereof is measured by the sensing circuitry 304.

FIG. 3B is a block diagram illustrating portions of exemplary circuitry 310 usable by the imager 102 shown in FIG. 1 according to certain other embodiments. The exemplary circuitry 310 shown in FIG. 3B may be used, for example, alone or in combination with the exemplary circuitry 300 shown in FIG. 3A. The exemplary circuitry 310 includes the switching power supply 302 electrically coupled to the power storage device 306 and a linear regulator 312 (a regulator in series). Advantageously, the linear regulator 312 generates less noise than the switching power supply 302.

The switching power supply 302 is configured to receive the input voltage VIN and to convert the input voltage VIN to a voltage signal that is usable by the linear regulator 312. The linear regulator 312 is also electrically coupled to the CCD sensor array 200 and the sensing circuitry 304. The linear regulator 312 is configured to convert the voltage signal provided by the switching power supply 302 to one or more voltages that are usable by the CCD sensor array 200 and the sensing circuitry 304. In certain embodiments, the power storage device 306 and/or the linear regulator 312 provide filtering to the voltage signal generated by the switching power supply 302.

In certain embodiments, during the time that the switching power supply 302 is off, the charge in the power storage device 306 may decrease below a level that is usable by the CCD sensor array 200 and/or the sensing circuitry 304. For example, in certain embodiments, the power storage device 306 includes one or more small capacitors configured to discharge faster than the time used to transfer a row of electronic charge in the horizontal register 206 to be sensed by the sensing circuitry 304 and digitized. The one or more capacitors may be selected based on such factors as filtering ability, physical size, cost, reliability, performance, preference, combinations of the foregoing, and the like. In certain such embodiments, the linear regulator 312 is configured to convert a decreasing charge provided by the power storage device 306 into one or more voltage signals that are usable by the CCD sensor array 200 and the sensing circuitry 304 throughout the time that the horizontal register 206 transfers a row of electronic charge from the horizontal register to be sensed by the sensing circuitry 304.

For example, in certain such embodiments, the switching power supply 302 is configured to provide a +18 VDC signal to the linear regulator 312 and the power storage device 306. The linear regulator 312 is configured to convert the +18 VDC signal to a regulated +15 VDC signal. When the switching power supply 302 is turned off, the linear regulator 312 draws current from the power storage device 306, causing the voltage provided to the linear regulator 312 to drop. During the time the switching power supply 302 is off, the voltage at the input of the linear regulator 312 may drop, for example, to a level in a range between approximately 300 mV and approximately 1.5 V. However, the linear regulator 312 is configured to continue to convert the decreasing voltage at its input to a +15 VDC signal usable by the CCD sensor array 200 and/or the sensing circuitry 304, at least during the time that a row of electronic charge is sensed.

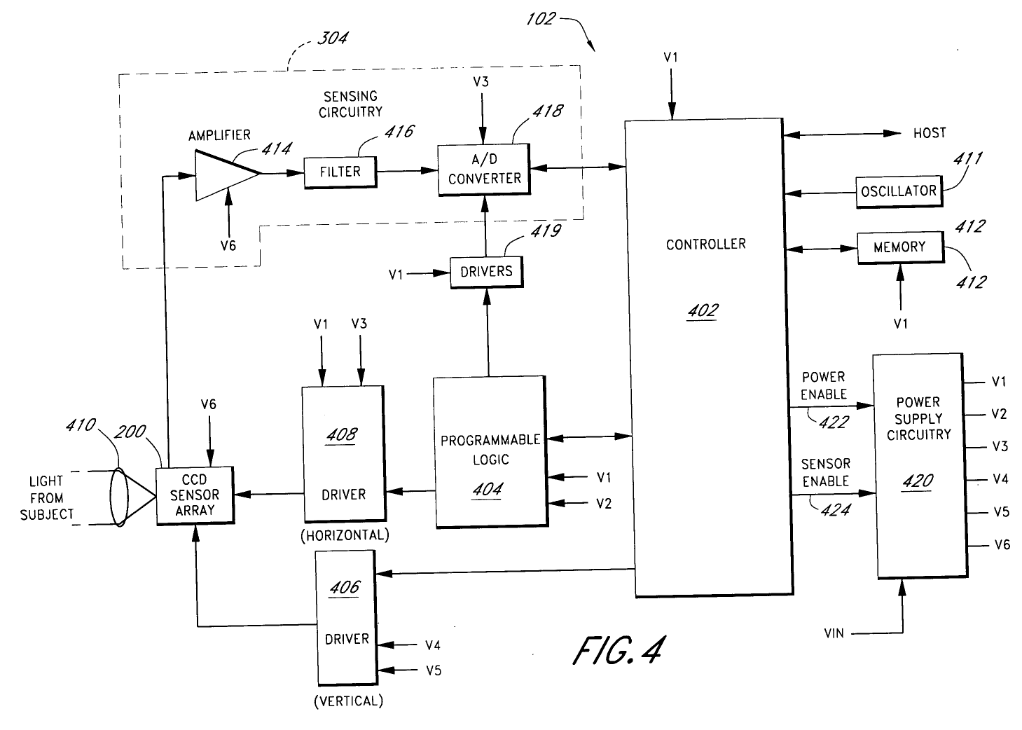

FIG. 4 is a block diagram illustrating portions of an exemplary imager 102, such as the imager 102 shown in FIG. 1 according to certain embodiments. The exemplary imager 102 includes a CCD sensor array 200, such as the CCD sensor array 200 shown in FIG. 2. The CCD sensor array 200 is electrically coupled to sensing circuitry 304, such as the sensing circuitry 304 discussed above. The exemplary imager 102 also includes a controller 402 configured to control the CCD sensor array 200 through a programmable logic device 404, a vertical driver 406 and a horizontal driver 408. The sensing circuitry 304, controller 402, programmable logic device 404, vertical and horizontal drives 406, 408 together in any combination or separately may be referred to as image acquisition circuitry. Other components and devices may also comprise image acquisition circuitry.

The CCD sensor array 200 is configured to receive light from an object through an optical system 410. As discussed above, in an exemplary embodiment, the optical system 410 includes a telescope, such as the telescope 104 shown in FIG. 1. In other embodiments, the optical system 410 includes, for example, a set of binoculars, a microscope, a surveillance system, a molecular imaging system, low light camera systems, or the like. Reduced noise during image capture may be useful for these applications. In certain embodiments, the CCD sensor array 200 comprises an electronic shutter so that the controller 402 can selectively control an exposure time during which electronic charges corresponding to a single image are collected in response to photons incident on the CCD sensor array 200, as discussed herein.

The CCD sensor array 200 may be a black and white image sensor or a color image sensor. In certain embodiments, the CCD sensor 200 comprises an interline/interlace CCD such as are used, for example, in digital video cameras. In exemplary embodiments, the CCD sensor array 200 comprises a CCD image sensor selected from part numbers ICX404AL, ICX404AK, or ICX254AL, each available from Sony Corp. of Tokyo, Japan. The programmable logic device 404 and drivers 406, 408 are configured to provide signals to control, for example, the CCD sensor array's vertical register 204 and horizontal register 206, as shown in FIG. 2.

As discussed above, the CCD sensor array 200 generates electronic charges at the individual photodiodes 202 (shown in FIG. 2) of the CCD sensor array 200 that is transferred and sensed by the sensing circuitry 304. The sensing circuitry 304 determines relative charge in electronic charge packets for different photodetectors 202 in the CCD sensor array 200. As discussed above, the amount of charge is quantified, for example, by measuring voltage or current. As shown in FIG. 4, in certain embodiments, the sensing circuitry 122 converts measurement of charge from the photodiodes 202 to a numerical value (i.e., digitization).

The sensing circuitry 304 includes an amplifier 414, a filter 416 and an analog-to-digital (A/D) converter 418. In various embodiments, the amplifier 414 is a low noise, high speed amplifier configured to amplify a signal corresponding to the electronic charge from the horizontal register 206 of the CCD sensor array 200 to provide sufficient signal levels to be digitized by the A/D converter 418. In an exemplary embodiment, the amplifier 414 is configured to receive a signal up to approximately 1.0 V from the horizontal register 206. In certain embodiments, the A/D converter can convert an analog signal as little as, for example, approximately 15 μV to a digital signal. In an exemplary embodiment, the amplifier 414 comprises an operation amplifier, part number AD8021, available from Analog Devices, Inc. of Norwood, Mass. The filter 416 is configured to remove or reduce at least a portion of the noise present in the output of the amplifier 414. In certain embodiments, the filter 416 comprises a low pass filter. In certain embodiments, the filter 416 has a time constant, for example, of approximately 22 ns. Other values may also be used.

The A/D converter 418 is configured to output a digital signal having a value indicative of the photo-electronic signal from the CCD sensor array 200 that is usable by the controller 402. In certain embodiments, the controller 402 and/or programmable logic device 404 control certain characteristics of the A/D converter 418 including, for example, gain and/or offset used to sense the signal levels present at the input of the A/D converter. As shown, the programmable logic device 404 may provide one or more signals to the A/D converter 418 through one or more drivers 419. In certain embodiments, the A/D converter 418 comprises a correlated double sampler configured to provide, for example, 16 bit digitization at speeds in a range between approximately 750 kHz and approximately 3.0 MHz. In certain other embodiments, the digitization speeds can be approximately 12.5 MHz. However, digitization speeds outside of these ranges are possible. Advantageously, the correlated double sampler reduces noise generated by the CCD sensor array 200 and/or other portions of the sensing circuitry 304. In an exemplary embodiment, the A/D converter 418 comprises an imaging signal processor, part number AD9826, available from Analog Devices, Inc. of Norwood Mass.

In certain embodiments, the controller 402 processes electronic images using data received from the CCD sensor array 200 through the sensing circuitry 304. For example, the controller 402 may format the electronic images and provide video data to a host system, such as the host system 118 shown in FIG. 1. As shown in FIG. 4, in certain embodiments, an oscillator 411 provides a time base signal to the controller 402. The controller 402 includes, by way of example, program logic or substrate configurations representing data and instructions, which operate as described herein. In other embodiments, the controller 402 can comprise processor circuitry, processors, general purpose single-chip or multi-chip microprocessors, digital signal processors, embedded microprocessors, microcontrollers, and the like. In an exemplary embodiment, the controller 402 comprises a microcontroller, part number CY7C68013, available from Cypress Semiconductor Corp. of San Jose, Calif.

In an exemplary embodiment, the controller 402 includes an interface for transmitting and receiving data through a USB bus. In addition, or in other embodiments, the controller 402 can also send video data, for example, to a memory device 412. The memory device 412 may be internal or external to the imager 102 and may include, for example, a removable or non-removable flash memory device, a miniature hard-drive, or another memory device associated with digital cameras, digital camcorders, cell phones, PDAs, other computing devices, or the like. Other types of controller 402 configurations are possible. Controller functions or portions thereof can also be provided by other components as well.

The exemplary imager 102 shown in FIG. 4 includes power supply circuitry 420 configured to receive an input voltage VIN and to convert the input voltage VIN to a plurality of voltage signals V1-V6 used to power the circuitry of the imager 102. As discussed above, the imager's circuitry, including the power supply circuitry 420, can generate noise that degrades the quality of the image produced by the imager 102. Thus, the controller 402 is advantageously configured to turn the circuitry on and off by providing, for example, a power enable signal 422 and a sensor enable signal 424 to the power supply circuitry 420. In particular, in various embodiments, at least portions of the imager's circuitry is turned off and/or disconnected from other circuitry while electronic charges from the CCD sensor array 200 are being measured to produce a digital signal by the sensing circuitry 304.

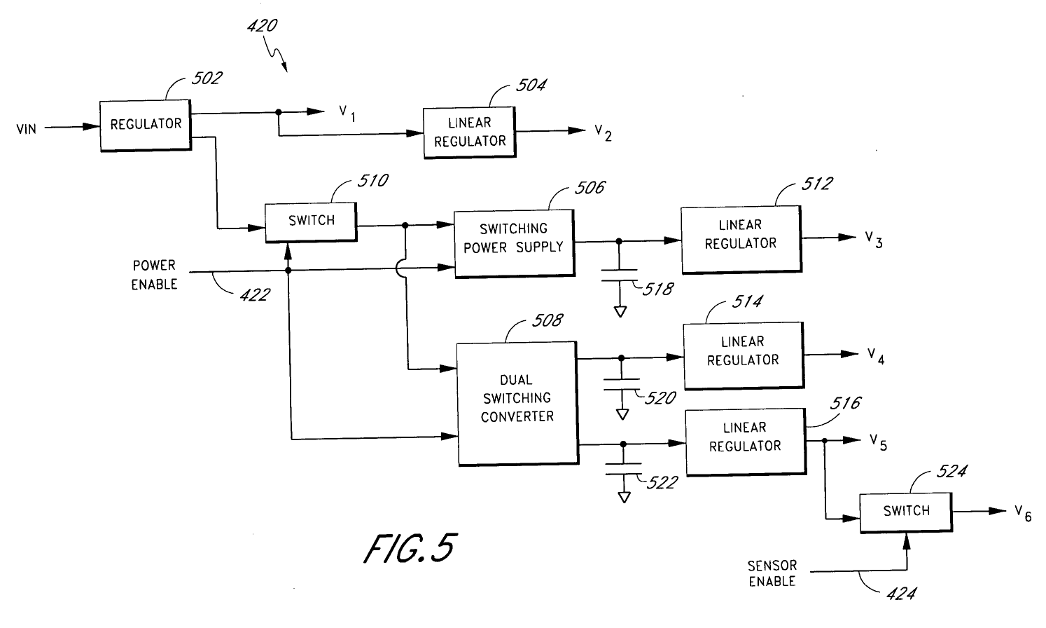

FIG. 5 is a block diagram of exemplary power supply circuitry 420 usable by the imager 102 shown in FIG. 1 according to certain embodiments. The power supply circuitry 420 includes a regulator 502 electrically coupled to a first linear regulator 504. The regulator 502 receives the input voltage VIN. As discussed above, in certain embodiments, the input voltage VIN is provided through a USB connection to the imager 102. In certain such embodiments, the regulator 502 comprises a USB power switch, part number TPS2151, available from Texas Instruments, Inc. of Dallas, Tex.

As shown, in certain embodiments, the regulator 502 has two outputs. The regulator 502 is configured to convert the input voltage VIN to a first voltage signal V1 provided to the first linear regulator 504 through a first output of the regulator 502. A second output of the regulator 502 is also electrically coupled to a switching power supply 506 and a dual switching converter 508 through a switch 510. In certain embodiments, the first output of the regulator 502 advantageously produces relatively little noise as compared to the switching power supply 506 and the dual switching power supply 508. In certain such embodiments, however, the second output of the regulator 502 includes an undesirable amount of noise. Thus, the switch 510 is advantageously configured to respond to the power enable signal 422 to electrically disconnect the second output of the regulator 502 from the switching power supply 506 and the dual switching converter 508.

The first linear regulator 504 is configured to convert the first voltage signal V1 to a second voltage signal V2. Advantageously, the first linear regulator 504 produces relatively little noise as compared to the switching power supply 506 and the dual switching converter 508. In an exemplary embodiment, the first linear regulator 504 comprises a voltage regulator, part number LM1117, available from National Semiconductor Corp. of Santa Clara, Calif.

The switching power supply 506 is electrically coupled to a second linear regulator 512 configured to provide a third voltage signal V3. A first output of the dual switching converter 508 is electrically coupled to a third linear regulator 514 configured to provide a fourth voltage signal V4. A second output of the dual switching converter 508 is electrically coupled to a fourth linear regulator 516 configured to provide a fifth voltage V5. Advantageously, the switching power supply 506 and the dual switching converter 508 can perform DC to DC power conversion more efficiently than the second linear regulator 512, the third linear regulator 514 and the fourth linear regulator 516. However, the switching power supply 506 and the dual switching converter 508 generate more noise than the second linear regulator 512, the third linear regulator 514 and the fourth linear regulator 516.

To reduce the noise generated by the switching power supply 506, a first capacitive element 518 is disposed between and coupled to the output of the switching power supply 506 and the input of the second linear regulator 512. Similarly, a second capacitive element 520 is disposed between and coupled to the output of the dual switching converter 508 and the input of the third line regulator 514. Also, a third capacitive element 522 is disposed between and coupled to the output of the dual switching converter 508 and the input of the fourth linear regulator 516. As shown in FIG. 5, the capacitive elements 518, 520, 522 are configured so as to remove or reduce high frequency components of the noise.

Additionally, when the switching power supply 506 is on or enabled, the first capacitive element 518 stores a charge. When the switching power supply 506 is turned off or disabled, the first linear regulator 512 uses the charge stored in the first capacitive element 518 as input and produces the third voltage signal V3. In an exemplary embodiment, the switching power supply 506 comprises a DC to DC converter, part number LT1613, available from Linear Technology Corp. of Milpitas, Calif., and the linear regulator 512 comprises a voltage regulator, part number LM1117, available from National Semiconductor Corp. of Santa Clara, Calif.

When the dual switching converter 508 is on or enabled, the second capacitive element 520 and the third capacitive element 522 store respective charge. When the dual switching converter 508 is turned off or disabled, the second linear generator 514 uses the charge stored in the second capacitive element 520 and produces the fourth voltage signal V4. Similarly, when the dual switching converter 508 is turned off or disabled, the third linear generator 516 uses the charge stored in the third capacitive element 522 to produce the fifth voltage signal V5. In certain embodiments, the power supply circuitry 420 also includes a switch 524 configured to selectively connect and disconnect the fifth voltage signal V5 (shown as a sixth voltage signal V6 at the output of the switch 524) from other circuitry in the imager 102 in response to the sensor enable signal 424. As discussed below, the switch 524 may be used to turn off circuitry such as the CCD sensor array 200.

In an exemplary embodiment, the dual switching converter 508 comprises a dual DC to DC converter, part number LT1945, available from Linear Technology Corp. of Milpitas, Calif. In certain such embodiments, the second linear regulator 514 comprises a voltage regulator, part number LM337, and the third linear regulator 516 comprises a voltage regulator, part number LM1117, both available from National Semiconductor Corp. of Santa Clara, Calif.

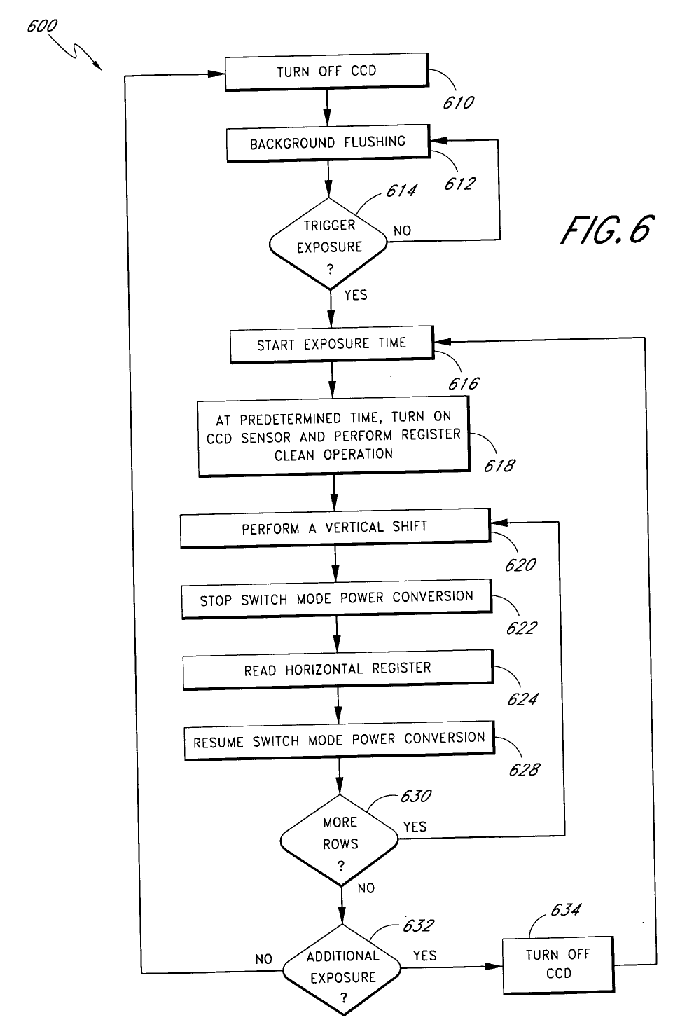

FIG. 6 illustrates an exemplary image acquisition process 600 according to certain embodiments. The process 600 is usable by an imager having a sensor array. For illustrative purposes, the process 600 is discussed with respect to the imager 102 shown in FIG. 4 having the CCD sensor array 200 shown in FIG. 2. However, the process 600 may be used to generate electronic images using a wide variety of imagers and/or sensor arrays. For example, the process 600 may be adapted for use with a CMOS sensor array. In various embodiments, the process 600 involves, in short, stopping switch mode power conversion while sensing data from a CCD sensor array 200.

Referring to FIGS. 4, 5 and 6, at block 610, the controller 402 turns off the CCD sensor array 200. In certain embodiments, turning off the CCD sensor array 200 disables the CCD sensor array's internal readout circuitry such as the vertical registers 204 and the horizontal register 206. However, with the readout circuitry disabled, the CCD sensor array can still be controlled through, for example, the drivers 406, 408 to perform background flushing, trigger exposures and store electronic charges generated by the photodiodes 202. In certain embodiments, the controller 402 turns off the CCD sensor array 200 by turning off or reducing the sixth voltage signal V6 provided to the CCD sensor array 200. In other embodiments, the controller 402 turns off the CCD sensor array 200 by controlling the sensor enable signal 424 to open the switch 524 so as to disconnect the sixth voltage signal V6 from the CCD sensor array 200.

At block 612, the controller 402 performs background flushing operations on the CCD sensor array 200. Background flushing removes or reduces electronic charges generated and/or stored in photodiodes 202 and registers 204, 206 of the CCD sensor array 200 when an electronic image is not being generated.

As shown in FIG. 6, the controller 402 continues the background flushing until it receives a command to trigger an exposure at block 614. The command to trigger the exposure may include, for example, a command from a user to the imager 102 to take a digital photograph. After receiving the command to trigger an exposure, at block 616, the controller 402 starts an exposure time. When the exposure time is started, the controller 402 stops the background flushing operation so that the electronic charges generated by the photodiodes 202 in response to photons incident thereon are stored in potential wells within the photodiodes 202.

At block 618, at a predetermined time before the end of the exposure time, the controller 402 turns on the CCD sensor array 200 and performs a register clean operation. In certain embodiments, the controller 402 turns on the CCD sensor array 200 by turning on or increasing the sixth voltage signal V6 provided to the CCD sensor array 200. In other embodiments, the controller 402 turns on the CCD sensor array 200 by controlling the sensor enable signal 424 to close the switch 524 so as to connect the sixth voltage signal V6 to the CCD sensor array 200. The register clean operation removes or reduces electronic charges stored in the vertical registers 204 and the horizontal register 206 so as to reduce error in the electronic image generated by the CCD sensor array 200.

At the end of the exposure time, the controller 402 commands the CCD sensor array 200 to transfer the electronic charges stored in at least a portion of the photodiodes 202 to the vertical registers 204. At block 620, the controller 402 commands the CCD sensor array 200 to perform a vertical shift operation. During the vertical shift operation, one row of electronic charge is shifted from the vertical registers 204 to the horizontal register 206.

At block 622, the controller 402 commands the power supply circuitry 420 to stop switch mode power conversion. In certain embodiments, the controller 402 stops switch mode power conversion by setting the power enable signal 422 so as to open the switch 510 and turn off the switching power supply 506 and the dual switching converter 508. As discussed above, after the switch mode power conversion is stopped, charge stored in the capacitive elements 518, 520, 522 is used to generate the third voltage signal V3, the fourth voltage signal V4, and the fifth voltage signal V5.

At block 624, the controller 402 commands the CCD sensor array 200 and sensing circuitry 304 to read the horizontal register 206, as discussed above. Advantageously, the noise generated by the switching power supply 506 and the dual switching converter 506 is removed from the input of the sensing circuitry 304 during the time that the horizontal register 206 is read. After the electronic charges are read from the horizontal register 206, at block 628, the controller 402 commands the power supply circuitry 420 to resume switch mode power conversion. The controller 402 resumes switch mode power conversion by setting the power enable signal 422 so as to close the switch 510 and turn on the switching power supply 506 and the dual switching converter 508. As discussed above, after the switch mode power conversion is resumed, the switching power supply 506 and the dual switching converter 508 charge the capacitive elements 518, 520, 522 and provide power to the linear regulators 512, 514, 516 so as to generate the third voltage signal V3, the fourth voltage signal V4, and the fifth voltage signal V5.

At block 630, the controller 402 queries whether there are more rows to be read from the vertical registers 204. If there are more rows, the process 600 returns to block 620 to repeat the process of shifting the next row of electronic charge from the vertical registers 204 to the horizontal register 206, stop switch mode power conversion, read the horizontal register 206 and resume switch mode power conversion. This process repeats until all of the rows have been read out of the CCD sensor array 200.

At block 632, the controller 402 queries whether there are additional exposures to acquire. In certain embodiments, the CCD sensor array 200 is configured to generate a first half of an image (e.g., an odd field) followed by a second half of the image (e.g., an even field). In certain such embodiments, the controller 634 turns off the CCD sensor array at block 634, as discussed above, and the process 600 returns to block 616 where another exposure time is started. Thus, for example, when short exposure times are used as compared to the time used to read out signals from the CCD sensor array 200 through the sensing circuitry 304, the process 600 allows two or more portions of the image to be generated at different times. Accordingly, portions of the image are less likely to be overexposed as other portions of the image are read out of the CCD sensor array 200. When relatively long exposure times are used as compared to the time used to read out signals from the CCD sensor array 200 through the sensing circuitry 304 (e.g., as may be the case in many low-lighting applications), an image may be generated using only one exposure. After all the exposures have been processed, as discussed above, the process 600 returns to blocks 610 and 612 where the controller 610 turns off the CCD sensor array 200 and resumes background flushing until it receives another command to trigger another exposure.

The process 600 may vary. For example, process steps may be added or removed and the order may be different. Similarly, the imaging system 100 and, in certain embodiments, the imager 102, may be different. For examples, various components may be removed, additional components may be added, and the arrangement of components may be different. Functions may be performed by different components, including combinations of components, and may be excluded or added. Still other configurations and designs are possible. Other applications and advantages not specifically recited herein are also possible.

Accordingly, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telescope comprising:
a telescope body;
telescope optics at least a portion of which are disposed in said telescope body, said telescope optics configured to receive light from a celestial object and form an optical image at an image plane;
a two-dimensional sensor array disposed at said image plane; and
power supply circuitry having first and second states, said power supply circuitry comprising:
at least one switching power supply configured to provide power to said two-dimensional sensor array in said first state; and
at least one non-switching power source configured to provide power to said two-dimensional sensor array in said second state,
wherein in said second state said at least one switching power supply is shut-off, thereby reducing noise.

2. The telescope of claim 1, further comprising sensing circuitry, wherein said at least one switching power supply is configured to provide power to said sensing circuitry in said first state, and wherein said at least one non-switching power source is configured to provide power to said sensing circuitry in said second state.

3. The telescope of claim 2, wherein said sensing circuitry comprises at least one of an amplifier, a filter and an analog to digital converter.

4. The telescope of claim 1, wherein said two-dimensional sensor array comprises a CCD array or a CMOS sensor array.

5. The telescope of claim 1, wherein said non-switching power supply comprises a shunt capacitor and a linear regulator.

6. The telescope of claim 1, further comprising a controller configured to send a signal to cause the said switching power supply to be shut-off.

7. A telescope comprising:
a telescope body;
telescope optics at least a portion of which is disposed in said telescope body, said optical imaging system configured to receive light from an object and form an optical image at an image plane;
a two-dimensional sensor array disposed at said image plane;
image acquisition circuitry; and
power supply circuitry having first and second states, said power supply circuitry comprising:
at least one switching power supply configured to provide power to said two-dimensional sensor array or said image acquisition circuitry in said first state; and
at least one non-switching power source configured to provide power to said two-dimensional sensor array or said image acquisition circuitry in said second state,
wherein in said second state, the power provided to said two-dimensional sensor array or image acquisition circuitry by said at least one switching power supply is reduced relative to the power provided to said two-dimensional sensor array or image acquisition circuitry by said at least one switching power supply in said first state, thereby reducing noise.

8. The telescope of claim 7, wherein said telescope body comprises a telescope tube.

9. The telescope of claim 7, wherein said optical imaging system comprises primary and secondary mirrors.

10. The telescope of claim 7, wherein said two-dimensional sensor array comprises an array of semiconductor photodetectors.

11. The telescope of claim 10, wherein said two-dimensional sensor array further comprises vertical and horizontal shift registers that shift charge from said photodetectors.

12. The telescope of claim 10, wherein said two-dimensional sensor array comprises a CCD array or a CMOS array.

13. The telescope of claim 7, wherein said image acquisition circuitry comprises at least one driver, programmable logic, a controller, or memory.

14. The telescope of claim 7, wherein said image acquisition circuitry comprises sensing circuitry configured to measure a parameter based on the quantity of photoelectrons generated by photodetectors in said two-dimensional sensor array.

15. The telescope of claim 14, further comprising a switch configured to switch said power supply circuitry to said second state when said sensing electronics measures said parameter.

16. The telescope of claim 15, wherein said at least one switch is configured to disable said switching power supply.

17. The telescope of claim 15, wherein said at least one switch is configured disrupt electrical connection from said switching power supply to said two-dimensional sensor array or at least a portion of said image acquisition circuitry.

18. The telescope of claim 15, wherein said switch is included in said power supply circuitry.

19. The telescope of claim 7, further comprising a controller that switches said power supply circuitry from said first state to said second state.

20. The telescope of claim 19, wherein said controller is configured to disable said switching power supply or to disrupt electrical connection from said switching power supply to said two-dimensional sensor array or at least a portion of said image acquisition circuitry.

21. The telescope of claim 7, wherein said switching power source is electrically coupled to said two-dimensional sensor array or said image acquisition circuitry through said non-switching power supply.

22. The telescope of claim 7, wherein said non-switching power source comprises a capacitor.

23. The telescope of claim 7, wherein said non-switching power source comprises a regulator.

24. The telescope of claim 7, wherein said at least one switching power supply is configured to provide power to said two-dimensional sensor array.

25. The telescope of claim 24, wherein said at least one switching power supply is disabled in said second state.

26. The telescope of claim 7, wherein in said second state, the power provided to said two-dimensional sensor array and said image acquisition circuitry by said at least one switching power supply is reduced relative to the power provided to said two-dimensional sensor array and image acquisition circuitry by said at least one switching power supply in said first state, thereby reducing noise.

27. A method of capturing an image formed by a telescope, the method comprising:
powering at least a portion of an imager comprising a two-dimensional sensor array and image acquisition circuitry using at least one switching power supply;
forming an optical image at said two-dimensional sensor array;
detecting a signal from said two-dimensional sensor array with sensing circuitry; and
powering said at least a portion of said imager with at least one non-switching power source instead of said switching power supply while detecting said signal.

28. The method of claim 27, wherein powering said at least a portion of said imager with at least one switching power supply comprises powering said two-dimensional sensor array, a controller, memory, programmable logic, at least one driver, or said sensing circuitry with said at least one switching power supply.

29. The method of claim 27, wherein said detecting said signal comprises measuring a parameter based on the amount of photoelectrons generated by photodetectors in said two-dimensional sensor array.

30. The method of claim 27, wherein powering said at least a portion of said imager with at least one non-switching power supply comprises powering said at least a portion of said imager with a capacitor or a regulator.
